(19) United States
(12) Patent Application Publication
(10) Pub. No.: US 2005/0212268 A1
(43) Pub. Date: Sep. 29, 2005

(54) Cover arrangment for a gas bag module

(75) Inventors: Ludwig Nagy, (US); Anton Fischer, (US); Martin Kolb, (US); Andreas Meyer, (US); Ralf Kucher, (US)

Correspondence Address: TAROLLI, SUNDMEIM, COVELL, & TUMMINO L.L.P.;1111 LEADER BLDG, 528 SUPERIOR AVENUE, CLEVELAND, OH, 64114-1400, US

(73) Assignee: TRW Automative GmbH

(21) Appl. No.: 11/087,907

(22) Filed: Mar. 23, 2005

(30) Foreign Application Priority Data
Mar. 23, 2004 (DE) 20 2004 004 556.7

(51) Int. Cl. B60R 21/16

(52) U.S. Cl. 280/728.2; 280/728.3

(57) ABSTRACT

A cover arrangement for a gas bag module (10) in a safety device for motor vehicles comprises a frame part (24), an opening (16) provided in the frame part (24) for accommodating a gas bag (20), and a cover (22) that in a non-activated condition of the gas bag module closes off the opening (16). The cover (22) and the frame part (24) are connected to each other by a latching connection, which has a latching hook (26) and a retaining part (48) for the latching hook (26). In an operating condition of the gas bag module the retaining part (48) is burst apart by means of the gas bag (20) acting upon the cover (22).

### TECHNICAL FIELD

The present invention relates to a cover arrangement for a gas bag module in a safety device for motor vehicles, comprising a frame part, an opening created in the frame part for accommodating a gas bag, and a cover that in the resting condition closes off the opening, the cover and the frame part being connected to each other by a latching connection.

### BACKGROUND OF THE INVENTION

Cover arrangements for gas bag modules of the aforementioned type are known from DE A1 38 43 686 referring to a cover arrangement for a gas bag system in a motor vehicle having a cover which, in a resting position, separates the gas bag system in its state of non-use from the passenger compartment and which, on the basis of a fixed vehicle interior part, has at least one point of attachment, which can be released in the event of an accident in order to discharge the gas bag into the passenger compartment. The cover that is acted upon by the gas bag remains connected to the vehicle interior part by a catch strap or tether.

### SUMMARY OF THE INVENTION

It is an object of the present invention to provide a cover arrangement that can be easily manufactured and that has improved functional reliability.

According to the invention, a cover arrangement for a gas bag module in a safety device for motor vehicles is made available, the cover arrangement comprising a frame part, an opening created in the frame part for accommodating a gas bag, and a cover that in a non-activated condition of the gas bag module closes off the opening, the cover and the frame part being connected to each other by a latching connection, which is characterized in that the latching connection has a latching hook and a retaining part for the latching hook, and the retaining part is adapted for being burst apart by the gas bag acting upon the cover in an operating condition of the gas bag module.

An unintentional opening is rendered impossible over the entire service life of the motor vehicle by configuring the latching connection between the cover and the frame in the form of a latching hook and a retaining part that serves as the abutment for the latching hook. In addition, assembling the cover arrangement is made substantially easier because the latching hook can have resilient properties, and therefore the entire cover does not have to be forced with great effort into the accommodating opening that is provided for this purpose in the dashboard. At the same time, the folded gas bag that is stored in the accommodating opening is better protected from a situation in which the gas bag fabric is caught between the cover and the frame part. The force necessary to burst apart the retaining part can be reliably set by selecting appropriate materials and/or by using materials of predetermined thicknesses, or by introducing predetermined breakpoints. The adjustment tests that are necessary to determine this retaining force are easier to arrange because it is not necessary to include the entire dashboard in the tests. In addition, the cover arrangement of the gas bag module according to the present invention can be manufactured in a simple injection-mold die. This adds to the cost savings substantially. At the same time, it is assured that in operation, i.e., when the cover arrangement is opened as a result of a vehicle accident, no loose parts are produced that could represent a danger of injury to the vehicle occupant.

The latching hook is preferably disposed on the cover and has a wedge-shaped hook section, which in the non-activated condition of the gas bag module contacts the retaining part, which is molded on the frame part. The wedge-shaped hook section of the latching hook tapers opposite the closing direction to a shoulder edge that protrudes from the leg of the hook. In this way, during operation, the transmission of force from the latching hook to the retaining part is substantially improved, so that the retaining part can be burst apart easily and the cover arrangement opened reliably.

In one especially preferred embodiment of the gas bag module cover arrangement according to the present invention, the wedge-shaped hook section is constituted by a bar that is molded on the latching hook and that has legs that run towards each other at an acute angle opposite the closing direction of the latching connection. Between the legs, it is possible additionally to arrange a reinforcement rib, which extends towards the acute angle. In this embodiment, a reliable and stable design of the latching hook is assured despite the savings on materials that are achieved thereby.

Furthermore, to make assembly easier, the latching hook can be configured in a wedge-shaped fashion and has a cross-section that tapers in the closing direction of the latching connection. As a result of the thrust slope that is produced in this way, it is significantly easier to mount the cover and to engage the latching hook in the retaining part. For this purpose, the latching hook can also be configured resiliently.

The retaining part is preferably configured as a bar that is molded on the frame part and that has, introduced in it, a predetermined breakpoint. The predetermined breakpoint can be defined, for example, by a reduced wall thickness of the bar or a tear line. Preferably, the bar is formed by legs which taper towards the middle of the bar. In this context, the legs can be arranged with respect to each other at an angle that corresponds to the angle formed by the wedge-shaped section on the latching hook. In this way, a latching connection is achieved that has a simple design and that is reliable. Finally, it is possible between the frame part and the legs of the retaining bar to provide one or more recesses, into which the legs during operation can be pushed out of the way when the retaining bar is burst open. In this way, it is possible to further reduce the force that is necessary during operation to open the cover arrangement.

Finally, the frame part can also have a wall section that is opposite the retaining part and that, together with the retaining part, defines an engagement opening for the latching hook. The wall section preferably functions as a protective wall for the gas bag as it deploys, and it assures that the gas bag fabric is not damaged by the burst bar segments of the retaining part. In addition, the wall section aids in the assembly and insertion of the latching hook, which, after being inserted, sits securely between the retaining bar and the wall section.

### BRIEF DESCRIPTION OF THE DRAWINGS

The present invention is described below on the basis of an exemplary embodiment with reference to the attached drawings. In the drawings:

FIG. 1 depicts a schematic sectional view of the upper part of a dashboard in a motor vehicle, having a gas bag module that is closed off by a cover arrangement;

FIG. 2 depicts a partial view of the frame part of the gas bag module cover arrangement according to the present invention;

FIG. 3 depicts a further partial view of the frame part of the gas bag module cover arrangement according to the present invention;

FIG. 4 depicts a schematic representation of a latching hook of the gas bag module cover arrangement according to the present invention;

FIG. 5 depicts a sectional view of the latching hook according to the present invention;

FIG. 6 depicts a sectional view of the retaining part of the gas bag module cover arrangement according to the present invention;

FIG. 7a depicts a top view of the retaining part in a non-activated condition; and

FIG. 7b depicts a top view of the retaining part in an operating condition, after the gas bag module cover arrangement has been opened.

### DETAILED DESCRIPTION OF PREFERRED EMBODIMENTS

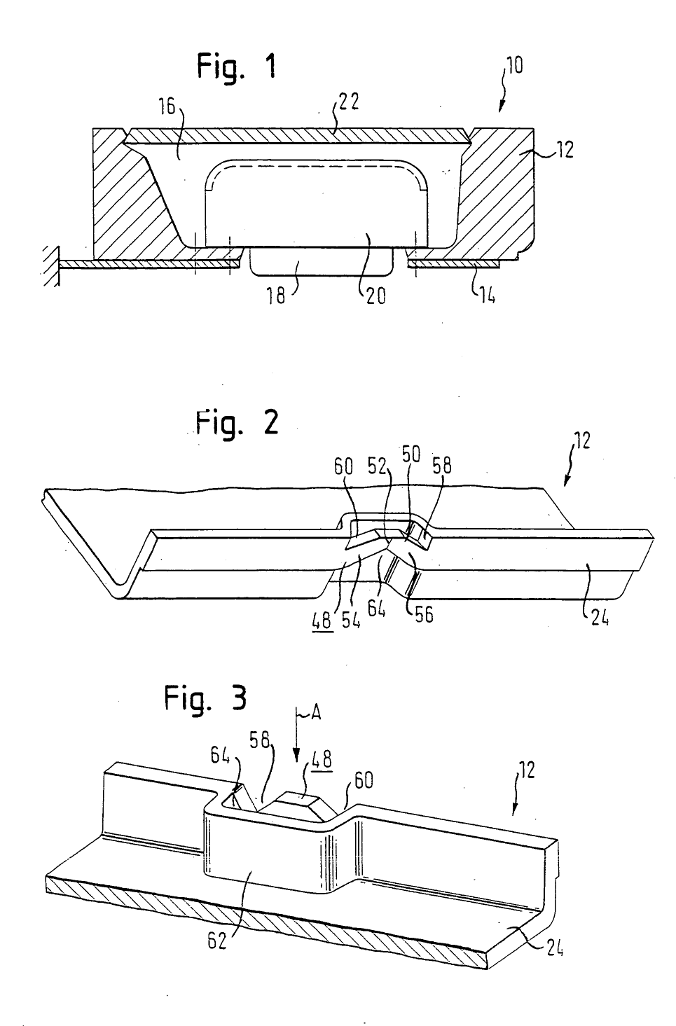

Reference is made to FIG. 1 which, in a schematic sectional view, depicts a gas bag module 10 which is introduced into the upper part of a dashboard 12 of a motor vehicle and which is fixedly connected to the vehicle by support means 14 using attachment elements that are not shown in greater detail. The gas bag module in a known manner has an opening 16 for accommodating a gas generator 18 and a gas bag 20 that is folded up on top of gas generator 18. In a resting condition, i.e., when the gas bag module is not activated, the gas bag module is closed off from the interior of the vehicle by a cover 22. The cover rests on a frame part 24 of dashboard 12 and is held in position by frame part 24 using at least one latching connection shown in detail in FIGS. 2 to 6.

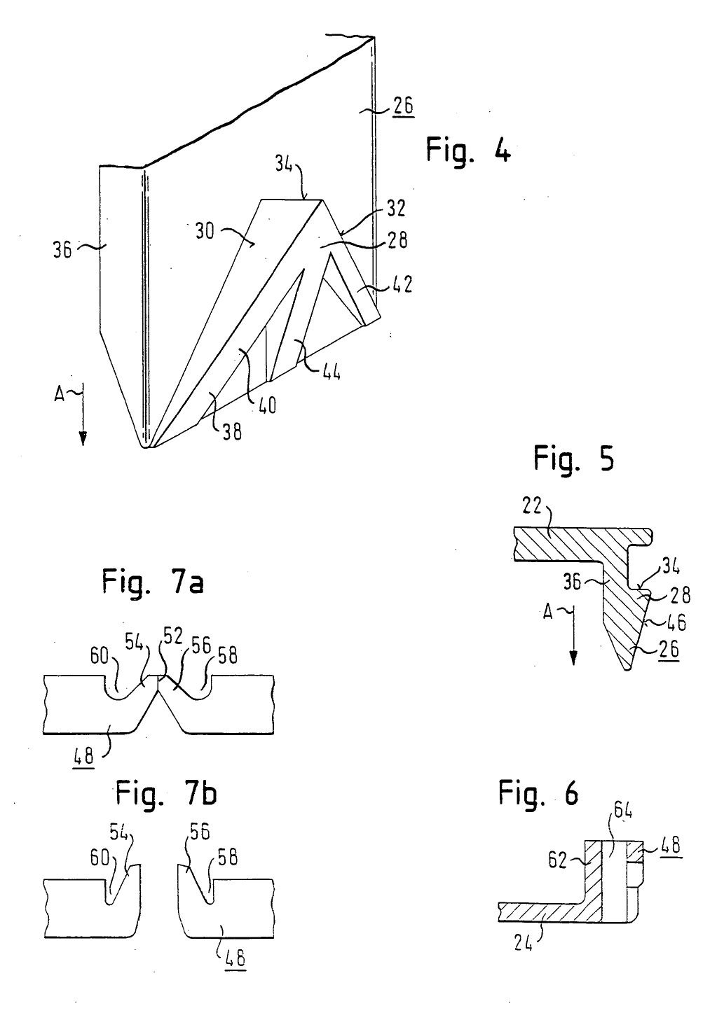

In the embodiment represented here, in order to produce the latching connection between cover 22 and frame part 24, cover 22 is provided with a latching hook 26. Latching hook 26, which is depicted in detail in FIGS. 4 and 5, has a wedge-shaped hook section 28, which is formed on the lower free end of the latching hook. Wedge-shaped hook section 28 that is molded on latching hook 26 is configured so that the two slanted areas 30, 32, facing each other, of hook section 28 taper opposite the closing direction of latching hook 26, as indicated by arrow A, and at their point of intersection they form a shoulder edge 34.

To save on material, slanted areas 30, 32 can be configured as one bar 38 that is molded on hook leg 36 and that has two bar legs 40, 42 that run towards each other at an acute angle opposite the closing direction A. At their meeting point, bar legs 40, 42 form shoulder edge 34. To improve the stability of wedge-shaped hook section 28, which is formed from bar legs 40, 42 that protrude from the hook leg, a reinforcement rib 44 can also be arranged between bar legs 40, 42, extending toward the acute angle, i.e., towards shoulder edge 34.

In addition, hook leg 36 of latching hook 26 at its lower, free end, seen in the closing direction A, is also configured in a wedge-shaped fashion and has a cross-section that tapers in the closing direction. As a result of this configuration of latching hook 26, a thrust slope 46 is generated that extends from shoulder edge 34 towards the lower, free end of hook leg 36 and that makes assembling cover 22 and producing the latching connection substantially easier. For this purpose, it can also be provided that latching hook 26, more specifically hook leg 36, is designed resiliently. The latching hook can then easily slide over the sliding surfaces that are formed in thrust slope 46 on reinforcement rib 44 and bar legs 40, 42, sliding on retaining part 48 that is formed in frame part 24 (FIGS. 2 and 3) and form the latching connection.

Retaining part 48, which in the embodiment shown here is depicted in greater detail in FIGS. 2 and 3, is configured as a retaining bar 50, which is molded on frame part 24, and into which a predetermined breakpoint is introduced, as indicated by line 52. In retaining bar 50, which is preferably configured as a single piece, predetermined breakpoint 52 is defined, for example, by a reduced wall thickness or a tear line. However, retaining bar 50 can also be configured in two parts so that the predetermined breakpoint is defined by a breakthrough point formed at the joining point of the two halves of the retaining bar.

In the embodiment shown here, integrally formed retaining bar 50 is made up of two legs 54, 56 that taper towards the center of the retaining bar and that are arranged at an angle with respect to each other. The angle formed by retaining bar legs 54, 56 preferably corresponds to the angle of the slanted areas 30, 32 at the shoulder edge 34 of wedge-shaped hook section 28 on latching hook 26. In this case, an especially reliable latching connection is produced by the matching positive fit between latching hook 26 and retaining part 48. However, the angle formed by retaining bar legs 54, 56 can also be greater than the angle formed on wedge-shaped hook section 28.

In the upper area of retaining part 48, i.e., the area that faces cover 22, it is also possible to provide recesses 58, 60, which are formed between frame part 24 and retaining bar legs 54, 56. These recesses 58, 60 make it possible for retaining bar legs 54, 56 to be moved out of the way during operation, i.e., when cover 22 is opened through being acted upon by gas bag 20. This function is shown in FIGS. 7a and 7b, FIG. 7a depicting retaining part 48 in the resting condition, i.e., when the cover arrangement is closed, and FIG. 7b in the final state, i.e., after the cover arrangement is opened. For reasons of simplicity, latching hook 26 is not shown in FIG. 7a.

Frame part 24 also has a wall section 62, which faces receptacle opening 16 and is situated opposite retaining part 48, and which is molded on frame part 24 and separates gas bag 20, accommodated in opening 16, from retaining part 48. Wall section 62, together with retaining part 48, therefore defines an engagement opening 64 for latching hook 26, as is shown in FIG. 6. In this way, it is achieved that gas bag 20, which is arranged in opening 16, cannot be caught between latching hook 26 and retaining part 48 when latching hook 26 is inserted into engagement opening 64. In addition, during the deployment process, the gas bag is protected from being damaged by the burst retaining bar halves 54, 56.

The following is an explanation of the operation of the cover arrangement for gas bag module 10 according to the present invention.

In the non-activated condition, cover 22 of gas bag module 10 rests on frame part 24 forming the border of an accommodating opening 16, which has a gas bag 20 that is folded up and disposed therein. On cover 22 at least one latching hook 26 is molded, which, along with retaining part 48 in frame part 24, creates a latching connection. For this purpose, latching hook 26 is introduced into engagement opening 64 between retaining part 48 and wall section 62 and, by its wedge-shaped hook section 28, engages behind retaining bar 50, which tapers towards its center. Legs 54, 56 of retaining bar 50 together form an angle which corresponds to the angle on wedge-shaped hook section 28 of latching hook 26. Slanted areas 30, 32 of wedge-shaped hook section 28 taper opposite the closing direction A while forming a shoulder edge 34 and therefore adjoin retaining bar legs 54, 56. At the same time, retaining bar 50 therefore constitutes a limit stop for shoulder edge 34 on free hook leg 36. In this state, shoulder edge 34 directly contacts predetermined breakpoint 52 in retaining bar 50.

When a sensor arranged in the vehicle determines that an accident has occurred, gas generator 18 of gas bag module 10 is activated by an electrical pulse. The gas generator produces a fluid that is under high pressure and that within a few milliseconds flows into and inflates gas bag 20. Due to the deployment of the gas bag, cover 22 is impacted upon by the gas bag and is blown off of gas bag module 10. During this process, shoulder edge 34, which is formed on wedge-shaped hook section 28 of latching hook 26, acts upon predetermined breakpoint 52 in retaining bar 50, so that retaining bar 50 is burst apart in a defined manner, and the latching connection is released. Retaining bar legs 54, 56, which are then separated from each other, slide on slanted areas 30, 32 of wedge-shaped hook section 28 and are pressed into recesses 58, 60. Thereupon, cover 22 exposes opening 16, and gas bag 20 can deploy unhindered towards the vehicle occupant to be restrained. In this context, gas bag 20, as it deploys, is protected by wall section 62 from being damaged by retaining bar legs 54, 56 after being burst apart. The force necessary for bursting retaining bar 50 can be set in a controlled fashion by the selection of a suitable material, by the thickness of the material, or by additional tear lines, so that, on the one hand, for the service life of the motor vehicle a reliable connection which prevents an unintended opening of the cover arrangement exists between cover 22 and frame part 24, and, on the other hand, during operation a high functional reliability is provided because the force required to burst open the cover arrangement can be set in a defined manner. The gas bag module cover arrangement according to the present invention can be manufactured with recourse to cost-effective injection-mold processes and well-known dies.

1. A cover arrangement for a gas bag module (10) in a safety device for motor vehicles, comprising a frame part (24), an opening (16) provided in the frame part (24) for accommodating a gas bag (20), and a cover (22) that in a non-activated condition of the gas bag module closes off the opening (16), the cover (22) and the frame part (24) being connected to each other by a latching connection, wherein the latching connection has a latching hook (26) and a retaining part (48) for the latching hook (26), and the retaining part (48) is adapted for being burst apart by means of the gas bag (20) acting upon the cover (22) in an operating condition of the gas bag module.

2. The cover arrangement of claim 1, wherein the latching hook (26) is molded on the cover (22).

3. The cover arrangement of claim 1, wherein the latching hook (26) has a wedge-shaped hook section (28), which in the non-activated condition contacts the retaining part (48).

4. The cover arrangement of claim 3, wherein the wedge-shaped hook section (28) tapers opposite a closing direction (A) of the latching hook (26), while forming a shoulder edge (34).

5. The cover arrangement of claim 3, wherein the wedge-shaped hook section (28) comprises a bar (38) that is molded on the latching hook (26) and that has legs (40, 42) that run towards each other at an acute angle.

6. The cover arrangement of claim 5, wherein between the legs (40, 42) a reinforcement rib (44) is arranged, which extends towards the acute angle.

7. The cover arrangement of claim 1, wherein the latching hook (26) is configured in a wedge-shaped fashion and has a cross-section that tapers in a closing direction (A) of the latching hook (26).

8. The cover arrangement of claim 1, wherein the retaining part (48) comprises a retaining bar (50) that is formed on the frame part.

9. The cover arrangement of claim 1, wherein the retaining bar (50) has legs (54, 56) that taper towards a center of the retaining bar (50).

10. The cover arrangement of claim 9, wherein the legs (54, 56) of the retaining bar (50) are arranged with respect to each other at an angle that corresponds to the wedge-shaped hook section (58).

11. The cover arrangement of claim 9, wherein recesses (58, 60) are provided between the frame part (24) and the legs (54, 56) of the retaining bar (50) for receiving the legs (54, 56) in an operating condition of the gas bag module.

12. The cover arrangement of claim 1, wherein the frame part (24) has a wall section (62) that is opposite the retaining part (48) and that, together with the retaining part (48), defines an engagement opening (64) for the latching hook (26).
